(19) United States
(12) Patent Application Publication
(10) Pub. No.: US 2017/0339626 A1
(43) Pub. Date: Nov. 23, 2017

(54) METHOD, APPARATUS AND SYSTEM

(71) Applicant: Nokia Solutions and Networks Oy, Espoo (FI)

(72) Inventors: Jari Pekka Mustajärvi, Espoo (FI); Mika Forssell, Tolkkinen (FI); Janne Petteri Tervonen, Espoo (FI)

(21) Appl. No.: 15/525,429

(22) PCT Filed: Nov. 12, 2014
(86) PCT No.: PCT/EP2014/074326

§ 371 Date: May 9, 2017

(51) Int. Cl. H04W 48/08; H04W 12/06; H04W 12/08; H04W 84/12

(52) U.S. Cl. CPC H04W 48/08; H04W 84/12; H04W 12/06; H04W 12/08

(57) ABSTRACT

There is provided a method comprising controlling receiving, at a user equipment, access information from a first network, said access information associated with a second network, the first and second network using different radio access technologies and using said access information in communication with the second network.

### FIELD

The present application relates to a method, apparatus and system and in particular but not exclusively, cellular network and wireless local area network (WLAN) aggregation.

### BACKGROUND

A communication system may be seen as a facility that enables communication sessions between two or more entities such as user terminals, base stations and/or other nodes by providing carriers between the various entities involved in the communications path. A communication system may be provided for example by means of a communication network and one or more compatible communication devices. The communications may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless communication system at least a part of communications between at least two stations occurs over a wireless link. Examples of wireless systems include mobile networks, satellite based communication systems and different wireless local networks, for example wireless local area networks (WLAN). Mobile networks may typically be divided into cells, and are therefore often referred to as cellular systems.

A user may access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

### SUMMARY

In a first aspect there is provided a method comprising controlling receiving, at a user equipment, access information from a first network, said access information associated with a second network, the first and second network using different radio access technologies and using said access information in communication with the second network.

The method may comprise providing user equipment identification information to at least one of the first network and the second network.

User equipment identification information may comprise at least one of a media access control address, temporary user equipment identity information and pseudo terminal identity information.

The method may comprise using said access information in an authentication procedure with the second network.

The authentication procedure may be at least one of an extensible authentication protocol procedure, a pre-shared key based authentication system, a fast basic service set transition scheme and a pair-wise master key based authentication system.

Said access information may comprise at least one of wireless local area network credentials, pseudo terminal identifier information and temporary user equipment identity information.

The first network may be a radio access network and the second network may be a wireless local area network.

In a second aspect there is provided a method comprising providing, by a first network, access information associated with a second network to a user equipment, said access information for communication with the second network, said first and second network using different radio access technologies.

The method may comprise controlling requesting, by the first network, access information from the second network.

The method may comprise allocating, by the first network, said access information and providing said access information to the second network.

The method may comprise receiving user equipment identification information from the user equipment.

User equipment identification information may comprise at least one of a media access control address, temporary user equipment identity information and pseudo terminal identity information.

Said access information may comprise at least one of wireless local area network credentials, pseudo terminal identifier information and temporary user equipment identity information.

The first network may be a radio access network and the second network may be a wireless local area network.

In a third aspect there is provided a method comprising detecting at a second network, a user equipment communicating with the second network, said user equipment authenticated with a first network, the first and second network using different radio access technologies and allowing the user equipment to access the second network based on access information used in the user equipment authentication with the first network.

The method may comprise controlling receiving access information from the first network, said access information allocated by the first network.

The method may comprise providing access information to the first network, in response to a request from the first network.

Allowing the user equipment to access the second network based on access information may comprise using said access information in an authentication procedure with the user equipment.

The authentication procedure may be at least one of an extensible authentication protocol procedure, a pre-shared key based authentication system, a fast basic service set transition scheme and a pair-wise master key based authentication system.

The method may comprise controlling receiving user equipment identification information from the user equipment.

User equipment identification information may comprise at least one of a media access control address, temporary user equipment identity information and pseudo terminal identity information.

Allowing the user equipment to access the second network based on access information may comprise using said user equipment identification information in an authentication procedure with the user equipment.

Said access information may comprise at least one of wireless local area network credentials, pseudo terminal identifier information and temporary user equipment identity information.

The first network may be a radio access network and the second network may be a wireless local area network.

In a fourth aspect there is provided an apparatus comprising means for performing a method according to any one of the first to third aspects.

In a fifth aspect there is provided a computer program product for a computer, comprising software code portions for performing the method of any one of the first to third aspects when said product is run on the computer.

In a sixth aspect there is provided apparatus comprising: at least one processor and at least one memory including a computer program code, the at least one memory and the computer program code configured to, with the at least one processor, cause the apparatus at least to: control receiving, at a user equipment, access information from a first network, said access information associated with a second network, the first and second network using different radio access technologies; and use said access information in communication with the second network.

The apparatus may be configured to provide user equipment identification information to at least one of the first network and the second network.

User equipment identification information may comprise at least one of a media access control address, temporary user equipment identity information and pseudo terminal identity information.

The apparatus may be configured to use said access information in an authentication procedure with the second network.

The authentication procedure may be at least one of an extensible authentication protocol procedure, a pre-shared key based authentication system, a fast basic service set transition scheme and a pair-wise master key based authentication system.

Said access information may comprise at least one of wireless local area network credentials, pseudo terminal identifier information and temporary user equipment identity information.

The first network may be a radio access network and the second network may be a wireless local area network.

In a seventh aspect there is provided an apparatus comprising at least one processor and at least one memory including a computer program code, the at least one memory and the computer program code configured to, with the at least one processor, cause the apparatus at least to: provide, by a first network, access information associated with a second network to a user equipment, said access information for communication with the second network, said first and second network using different radio access technologies.

The apparatus may be configured to control requesting, by the first network, access information from the second network.

The apparatus may be configured to allocate, by the first network, said access information and provide said access information to the second network.

The apparatus may be configured to receive user equipment identification information from the user equipment.

User equipment identification information may comprise at least one of a media access control address, temporary user equipment identity information and pseudo terminal identity information.

Said access information may comprise at least one of wireless local area network credentials, pseudo terminal identifier information and temporary user equipment identity information.

The first network may be a radio access network and the second network may be a wireless local area network.

In an eighth aspect there is provided an apparatus comprising at least one processor and at least one memory including a computer program code, the at least one memory and the computer program code configured to, with the at least one processor, cause the apparatus at least to: detect at a second network, a user equipment communicating with the second network, said user equipment authenticated with a first network, the first and second network using different radio access technologies and allow the user equipment to access the second network based on access information used in the user equipment authentication with the first network.

The apparatus may be configured to control receiving access information from the first network, said access information allocated by the first network.

The apparatus may be configured to provide access information to the first network, in response to a request from the first network.

The apparatus may be configured to use said access information in an authentication procedure with the user equipment.

The apparatus may be configured to control receiving user equipment identification information from the user equipment.

User equipment identification information may comprise at least one of a media access control address, temporary user equipment identity information and pseudo terminal identity information.

The apparatus may be configured to use said user equipment identification information in an authentication procedure with the user equipment.

The authentication procedure may be at least one of an extensible authentication protocol procedure, a pre-shared key based authentication system, a fast basic service set transition scheme and a pair-wise master key based authentication system.

Said access information may comprise at least one of wireless local area network credentials, pseudo terminal identifier information and temporary user equipment identity information.

The first network may be a radio access network and the second network may be a wireless local area network.

In a ninth aspect there is provided a computer program embodied on a non-transitory computer-readable storage medium, the computer program comprising program code for controlling a process to execute a process, the process comprising: controlling receiving, at a user equipment, access information from a first network, said access information associated with a second network, the first and second network using different radio access technologies and using said access information in communication with the second network.

The process may comprise providing user equipment identification information to at least one of the first network and the second network.

User equipment identification information may comprise at least one of a media access control address, temporary user equipment identity information and pseudo terminal identity information.

The process may comprise using said access information in an authentication procedure with the second network.

The authentication procedure may be at least one of an extensible authentication protocol procedure, a pre-shared key based authentication system, a fast basic service set transition scheme and a pair-wise master key based authentication system.

Said access information may comprise at least one of wireless local area network credentials, pseudo terminal identifier information and temporary user equipment identity information.

The first network may be a radio access network and the second network may be a wireless local area network.

In a tenth aspect there is provided a computer program embodied on a non-transitory computer-readable storage medium, the computer program comprising program code for controlling a process to execute a process, the process comprising: providing, by a first network, access information associated with a second network to a user equipment, said access information for communication with the second network, said first and second network using different radio access technologies.

The process may comprise controlling requesting, by the first network, access information from the second network.

The process may comprise allocating, by the first network, said access information and providing said access information to the second network.

The process may comprise receiving user equipment identification information from the user equipment.

User equipment identification information may comprise at least one of a media access control address, temporary user equipment identity information and pseudo terminal identity information.

Said access information may comprise at least one of wireless local area network credentials, pseudo terminal identifier information and temporary user equipment identity information.

The first network may be a radio access network and the second network may be a wireless local area network.

In an eleventh aspect there is provided a computer program embodied on a non-transitory computer-readable storage medium, the computer program comprising program code for controlling a process to execute a process, the process comprising: detecting at a second network, a user equipment communicating with the second network, said user equipment authenticated with a first network, the first and second network using different radio access technologies and allowing the user equipment to access the second network based on access information used in the user equipment authentication with the first network.

The process may comprise controlling receiving access information from the first network, said access information allocated by the first network.

The process may comprise providing access information to the first network, in response to a request from the first network.

Allowing the user equipment to access the second network based on access information may comprise using said access information in an authentication procedure with the user equipment.

The authentication procedure may be at least one of an extensible authentication protocol procedure, a pre-shared key based authentication system, a fast basic service set transition scheme and a pair-wise master key based authentication system.

The process may comprise controlling receiving user equipment identification information from the user equipment.

User equipment identification information may comprise at least one of a media access control address, temporary user equipment identity information and pseudo terminal identity information.

Allowing the user equipment to access the second network based on access information may comprise using said user equipment identification information in an authentication procedure with the user equipment.

Said access information may comprise at least one of wireless local area network credentials, pseudo terminal identifier information and temporary user equipment identity information.

The first network may be a radio access network and the second network may be a wireless local area network.

In the above, many different embodiments have been described. It should be appreciated that further embodiments may be provided by the combination of any two or more of the embodiments described above.

### LIST OF DRAWINGS

Embodiments will now be described, by way of example only, with reference to the accompanying Figures in which:

FIG. 1 shows a schematic diagram of an example communication system comprising a base station and a plurality of communication devices;

FIG. 2 shows a schematic diagram, of an example mobile communication device;

FIGS. 3A, 3B and 3C show some example flowcharts of method(s) of authenticating a UE;

FIG. 4 shows an example timing diagram of an example method of authenticating a UE;

FIG. 5 shows a schematic diagram of an example control apparatus;

FIG. 6 shows an example apparatus for authenticating a UE;

FIG. 7 shows an example apparatus for authenticating a UE;

FIG. 8 shows an example apparatus for authenticating a UE;

### DESCRIPTION OF SOME EMBODIMENTS

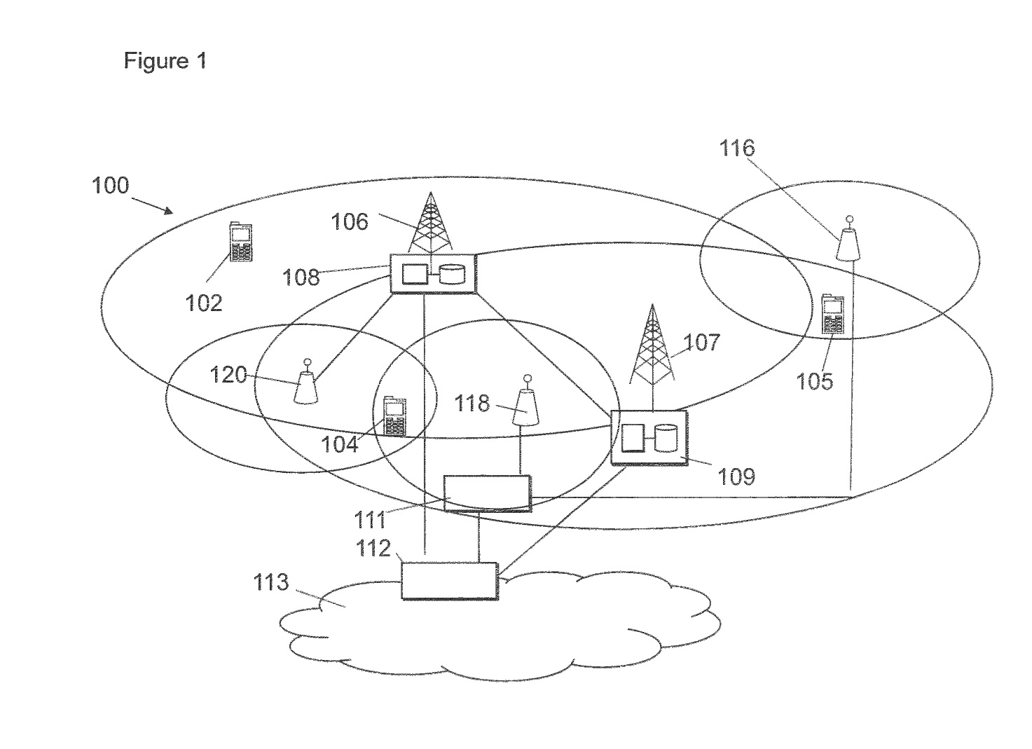

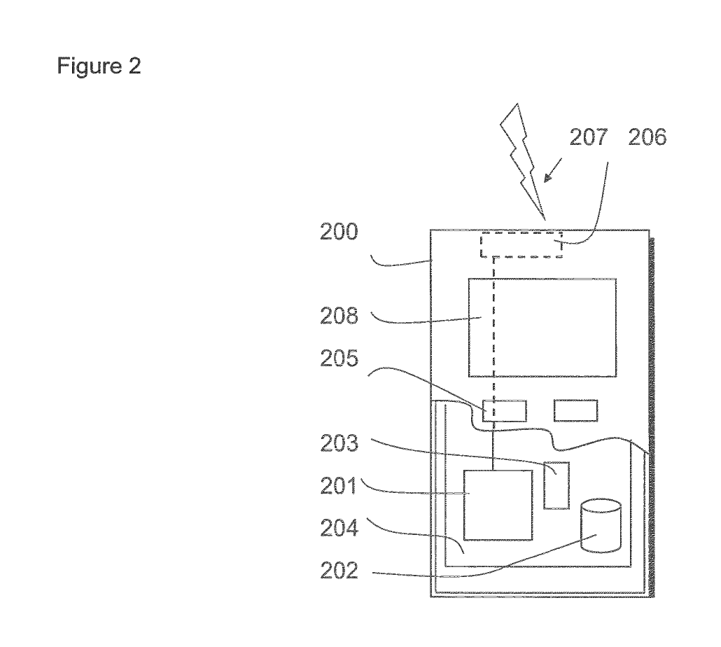

Before explaining in detail the examples, certain general principles of a wireless communication system and mobile communication devices are briefly explained with reference to exemplifying FIGS. 1 to 2 to assist in understanding the technology underlying the described examples.

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

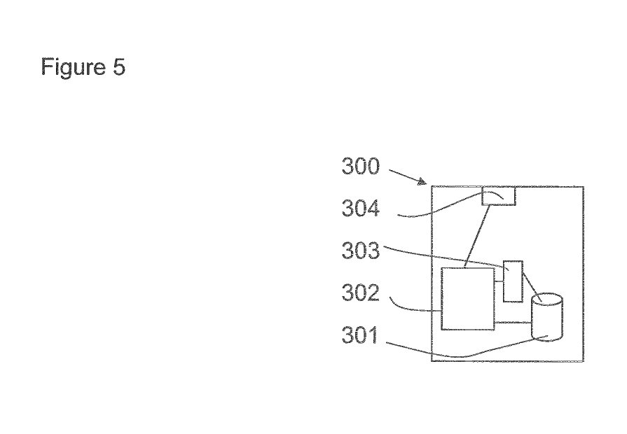

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station may be interconnected with other control entities. The control apparatus is typically provided with memory capacity and at least one data processor. The control apparatus and functions may be distributed between a plurality of control units. In some systems, the control apparatus may additionally or alternatively be provided in a radio network controller. The control apparatus may provide an apparatus such as that discussed in relation to FIG. 5.

LTE systems may however be considered to have a so-called “flat” architecture, without the provision of RNCs; rather the (e)NB is in direct communication with the core network, namely system architecture evolution gateway (SAE-GW) and mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations or nodes 106 and 107 are shown as connected to a wider communications network 113 via gateway 112. A further gateway function may be provided to connect to another network.

The smaller base stations or nodes (access nodes, APs) 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

The embodiments are not, however, restricted to the system given as an example but a person skilled in the art may apply the solution to other communication systems provided with necessary properties. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples include a mobile station (MS) or mobile device such as a mobile phone or what is known as a ‘smart phone’, a computer provided with a wireless interface or other wireless interface facility (e.g., USB dongle), personal data assistant (PDA) or a tablet (laptop, touch screen computer) provided with wireless communication capabilities, or any combinations of these or the like. Some other examples of user devices (UE) are a game console, notebook, multimedia device and a device using a wireless modem (alarm or measurement device, etc.). A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus may be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone may be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access). A base station may provide coverage for an entire cell or similar radio service area.

3GPP has standardized mobile wireless access technologies such as LTE and 3G, while the WLAN mobile wireless access is based on the IEEE standard 802.11. UEs may be equipped with at least one 3GPP RAT as well as a WLAN radio interface. WLAN access points may be user-deployed and are operating in unlicensed spectrum, whereas 3GPP base stations and UEs may be owned by operators and use licensed spectrum. Recently, operators have started deploying WLAN APs as well, and are seeking better coordination between the capacity provided between WLAN and the 3GPP networks. While 3GPP may use licensed spectrum, an initiative known as LTE-U, officially Licenced Assisted Access (LAA) for LTE involves using unlicensed spectrum, also used by WLAN.

A WLAN leg may be set up as a secondary radio bearer between UE and an access network, similarly to unlicensed LTE use. The evolved packet system (EPS) itself may not be aware of the WLAN; the WLAN may convey LTE user plane packets between UE and eNB as if they were originally delivered via LTE leg (WLAN indication may be provided to EPS e.g. for reduced charging purposes). A UE may combine the downlink payload from the two interfaces before delivering it to an end application. UE may also deliver uplink data via either interface without applications being aware of it. eNB S1 interface may act as an anchor point in network side. This process may be known as tight interworking.

The term RAN is used to indicate any 3GPP radio access network entity where radio resource control (RRC) functionality resides. In LTE this may be an eNB node while in WCDMA it may be RAN node (NodeB and/or RNC). The WLAN term refers to WLAN access network unless otherwise stated. EPS is LTE packet core network.

A WLAN AP may be either co-located with the RAN, integrated into the RAN or a remote entity with suitable data and control interface with the RAN. The use of WLAN may be controlled by the RAN and all WLAN traffic may be routed through the RAN. The WLAN may not be visible to the EPS (other than optionally radio access technology identity (RAT ID) provided to EPS). UE and RAN may choose whether each payload packet is delivered via WLAN or RAN radio leg. From a user datagram protocol (UDP) and transmission control protocol (TCP) point of view the two interfaces may operate as one. The aggregation may complement ANDSF and RAN Offload solutions.

When a UE connects to a RAN and establishes 3GPP connection, the UE is typically authenticated and/or authorized and necessary security mechanisms (e.g., ciphering and/or integrity) are established for radio communication. In order to use WLAN radio, the same level of security may be expected. In 3GPP domain this may mean use of WPA2 (Wi-Fi Protected Access) security protocols in the WLAN radio. Required authentication and security key generation may be based on SIM credentials as in RAN. This may be completely independent of established 3GPP security and involves use of remote authentication, authorisation and accounting (AAA) and home subscriber server (HSS) resources. EAP (extensible authentication protocol)-SIM (subscriber identity module), EAP-AKA (authentication and key agreement) and EAP-AKA-Prime are currently specified 3GPP security mechanisms on WLAN side. Since a UE already has been authenticated and authorized in RAN side it would be beneficial if this security could be reused in WLAN side for carrier aggregation.

It may also be desirable to identify a device in WLAN side when WLAN interface is being created for aggregation and authorize this in RAN side. Identification should be reliable and secure, since traffic may be combined in eNB before it is delivered to EPS. Currently, WLAN and RAN may not share an identity that may be used to associate the two legs together.

Traffic may be sent via EPS core and charged accordingly. The S1 interface between eNB and EPS core may be extended to include statistics about WLAN usage. Double charging on WLAN side should be avoided as WLAN networks may generate accounting records when remote authentication is used.

A pseudo terminal identifier (PTID) based solution allows RAN and WLAN to negotiate used user identifier for WLAN access. PTID is a RAN allocated temporary/one-time User-Name to be used in the WLAN access. The WLAN will request such a User-Name from the UE when UE connects to the WLAN which require use of EAP based authentication mechanisms (Open Authentication). This User-Name has a format which allows the WLAN to recognize it as WLAN Offload User-Name and is able to intercept the authentication and request further authorization from the RAN side. The security mechanism includes use of EAP-SIM/AKA/AKA-Prime for authentication and authentication and therefore happens in home HSS server. This may not be desirable in order to achieve fast access and to keep WLAN internal to RAN. Other authentication mechanisms may be used assuming they are secure and robust enough, such as EAP-TTLS based on certificates or EAP-PEAP based on protected username & password (that need to be complex enough).

An alternative solution introduces exchange of permanent/temporary/one-time WPA2 pre-shared key (PSK) security keys or pair-wise master key (PMK) or alike over 3GPP radio to the UE to be used to setup WPA2 security over WLAN radio with the WLAN. UE provides its media access control (MAC) address to the RAN and RAN negotiates the PSK or PMK to be used with the WLAN.

As a result of PSK/PMK exchange both the UE and WLAN are able to setup a pair-wise master key security association (PMKSA) specified in 802.11 specifications. PMSKA context is normally created as a result of successful EAP authentication or from PSK. The key components are MAC address and PMK.

In case of PSK the PMK is derived out of PSK locally by UE and WLAN. UE and WLAN may communicate securely if they are able to use same PMKSA.

Normally in EAP authentication the PMK is derived out of EAP authentication keys known to UE and home authentication server (AAA/HSS). This may be skipped and the keys may be created locally in the RAN.

In both of these mechanisms essentially all information required to create the security association is exchanged between UE, RAN and WLAN via secure UE/RAN connection and RAN/WLAN connection. This way UE may skip EAP authentication procedure completely in the WLAN and use 802.11 specified 4-way handshake directly to prove knowledge of the security keys and thereby allowing WLAN and RAN to identify the offload scenario.

Fast BSS (base station subsystem) transition, initially introduced in 802.11r and included in 802.11-2012 specification, defines a mechanism to avoid subsequent authentication phase when a UE is performing a handover between two WLAN APs. This method is only applicable within a single WLAN network. The target and source WLAN APs exchange specific security keys derived from PMK allowing the UE to re-establish WLAN session without full authentication. 802.11 does not specify how these keys are exchanged between APs; typically this is supported if the two AP's are managed by same WLAN controller. As an option this could be extended to cover 3GPP aggregation. RAN could assume source WLAN AP role in this and prepare the UE and target WLAN for fast BSS transition.

The main motivation to use regular local EAP based or PSK mechanisms over PMKSA exchange is compatibility with existing WLAN installations. No new WLAN HW or even SW modifications are required; it may be implemented in the network side just via configuration. By introducing local AAA server the modifications are needed only in RAN on network side. RAN could configure AAA server via existing configuration interfaces the AAA systems typically have. UE would need adaptations as LTE chip would have to configure WLAN settings for the UE according to RAN commands. Mechanisms based on PMSKA transfer or fast BSS transition may in some circumstances provide faster connection times but go deep into WLAN chip level and UE (software/hardware) SW/HW implementations and are not readily available.

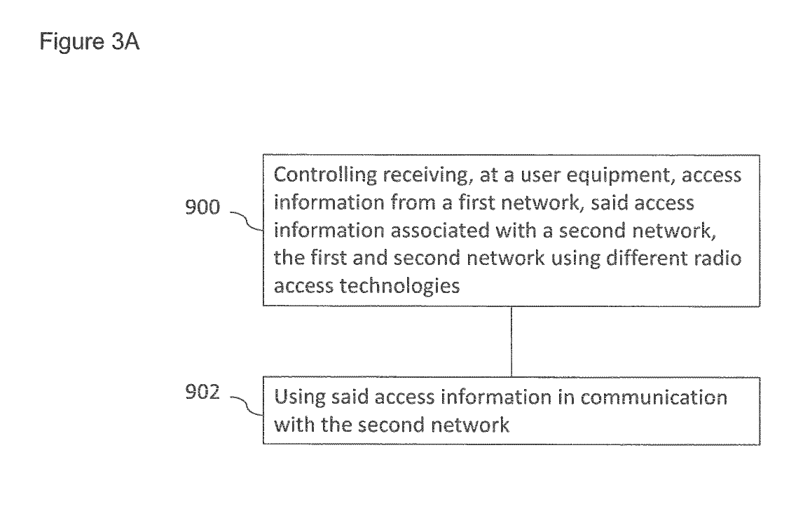

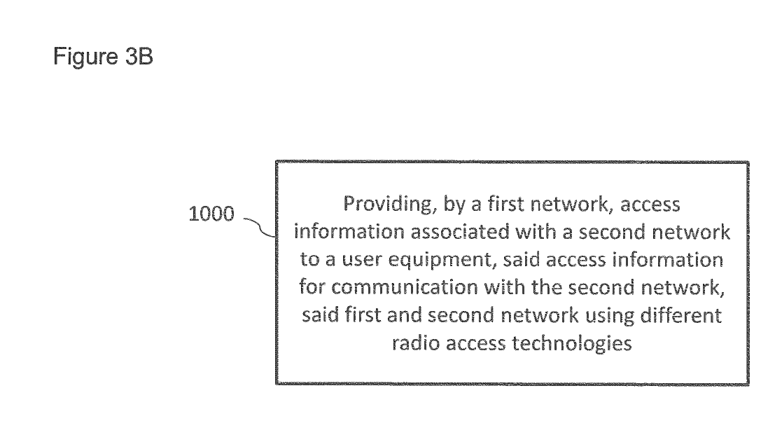

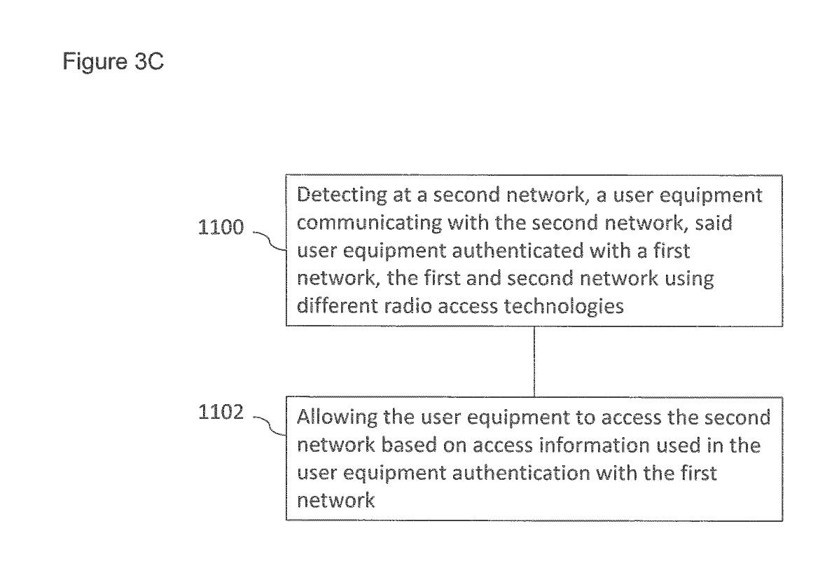

The PTID concept may be evolved to introduce local RAN controlled authentication. FIG. 3A shows an example of a method of authenticating a UE in a WLAN, wherein the WLAN is to be used as a secondary radio bearer. The method comprises, in block 900, controlling receiving, at a user equipment, access information from a first network, said access information associated with a second network, the first and second network using different radio access technologies. In block 902, the method comprises using said access information in communication with the second network.

FIG. 3B shows an example of a method of authenticating a UE according to another embodiment. The method comprises, in a step 1000, providing, by a first network, access information associated with a second network to a user equipment, said access information for communication with the second network, said first and second network using different radio access technologies.

FIG. 3C shows an example of a method of authenticating a UE according to another embodiment. The method comprises, in a first step 1100, detecting at a second network, a user equipment communicating with the second network, said user equipment authenticated with a first network, the first and second network using different radio access technologies. In a second step the method comprises allowing the user equipment to access the second network based on access information used in the user equipment authentication with the first network.

Radio access technologies may comprise Long Term Evolution (LTE), Long-Term Evolution Advanced (LTE-A), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks and mobile ad-hoc networks (MANETs). In the method described above, the first network may be RAN and the second network may be WLAN.

An embodiment of a method may comprise providing UE identification information to a first network and/or to a second network, for example providing UE identification information to an eNB. UE identification information may comprise at least one of a media access control address, temporary user equipment identity information and pseudo terminal identity information. Temporary user equipment identity information and pseudo terminal identity information may be allocated in the first network and provided to UE, for providing to the second network. Temporary user equipment identity information may also be requested by the first network from the second network and provided to the UE via the first network.

Access information may comprise credentials to be used for ciphering, authentication and authorization in the second network. Access information may comprise a secret and a username to be exchanged between a first network and a second network to establish common identity. This username may be attached with a specific realm. This realm is either generally known to be associated with offload or aggregation use or locally in RAN/WLAN where it was allocated.

Access information may comprise WLAN authentication credentials, such as a WLAN provided secret, WLAN identification information, a RAN allocated temporary UE identity, such as PTID, WLAN network identity such as MAC address or SSID, a pre-shared key (PSK), a pair-wise master key (PMK), etc.

Access information may be delivered to the UE over the first network, e.g. RAN, interface.

The access information may be used in an authentication procedure with the second network. For example, the access information may be used in any one of an extensible authentication protocol procedure, a pre-shared key (PSK) based authentication system, a fast basic service set transition scheme and pair-wise master key (PMK) based authentication system.

In an embodiment, a method may comprise providing, by a first network, access information associated with a second network to a user equipment, said access information for communication with the second network, said first and second network using different radio access technologies.

In an embodiment, the method may comprise detecting at a second network, a user equipment communicating with the second network, said user equipment authenticated with a first network, the first and second network using different radio access technologies; and allowing the user equipment to access the second network based on access information used in the user equipment authentication with the first network.

the method may comprise controlling requesting, by the first network, access information from the second network. Alternatively, or in addition, the method may comprise allocating, by the first network, said access information and providing said access information to the second network.

For example, WLAN security may be established using EAP-TTLS (tunneled transport layer security, EAP-PEAP (protected extensible authentication protocol) or any other suitable EAP methods which allow a UE to setup a secure channel with the WLAN based on, for example, public key cryptography using plain text username, server certificates and Diffie-Hellman exchange. In one example, once a secure channel has been established MS-CHAPV2 (Microsoft challenge-handshake authentication protocol) exchange with the username and secret may be executed within the secure channel to prove user identity. That is, EAP authentication may be executed locally in the second network or WLAN, without reaching operator AAA machinery.

Access information may comprise suitable EAP credentials for legacy WLAN 802.1x authentication. These credentials may be managed by RAN node. The credentials may be provided both to a UE and to a WLAN for WLAN offload/aggregation. In simplest form there is an AAA server which authenticates the credentials provided by UE to the WLAN. RAN maintains the credentials used by this AAA server. The credentials could include username of form user@realm and a password. A UE could authenticate, for example, using EAP-TTLS/MSChapV2 authentication mechanism. The realm component would be used to locate the AAA server. Since RAN is able to manage these credentials, RAN may effectively control UE's lifetime in the WLAN. RAN could also assume the AAA role and locally manage whole WLAN usage. This may not require any new developments for the WLAN network entities and could be compatible with current WLAN networks. The credentials identify the UE to the WLAN.

In a pre-shared key (PSK) based authentication mechanism, RAN is able to manage the PSK keys for the users. PSK may be used in WLAN networks which broadcast support for PSK authentication. RAN could allocate dedicated PSK for each authorized UE and associate it with a UE MAC address. RAN may indicate authorized [UE_MAC,PSK] tuples to the WLAN and also manage this tuple lifetime in the WLAN according to WLAN offload/aggregation policies it may have.

Shared PSK may also be used. In this case eventually all the devices could potentially eventually learn the PSK and authorization could be done based solely on UE MAC address. This mode is supported already by some WLAN networks. RAN may need to manage these MAC addresses in the WLAN node (one of WLAN AP/WLAN Controller/AAA server). WLAN networks may support only one shared PSK and this mechanism may require user specific PSK values.

Pair-wise-master key (PMK) based authentication may also be used. This is available in WLAN networks which indicate support for EAP authentication. Normally the PMK is generated locally in UE and AAA server after successful EAP authentication from exchanged data or from local key generation sources like SIM card; both UE and AAA server are able to generate same key. The AAA server provides the (uplink) UL and (downlink) DL key to WLAN network to setup secure communication with the UE. Once UE learns the PMK it may establish subsequent WLAN connections with the same AP using this PMK as long as WLAN network is willing to use the key. PSK is one form of PMK. If RAN manages these PMK keys for the UEs and WLAN networks and provides the keys to the UEs and WLAN networks, then the UE may skip an EAP authentication procedure and confirm key ownership by executing so called 4-way handshake with the AP. The handshake uses PMK derived keys in both directions and both end points may verify the peer has correct key. PMK key may be stored in a pair-wise master key security association (PMKSA) which both the UE and WLAN will create after successful EAP authentication. The PMKSA could be created based on RAN input in this case.

A method such as that of FIG. 3 allows RAN and WLAN to keep the WLAN authentication within the RAN domain and not involve home AAA or HSS servers. RAN may resume full control over the WLAN usage.

The same WLAN network may be used for any public WLAN access if so desired. Offload traffic may be identified easily in WLAN (based on realm in user-identity) and handled accordingly.

Since a WLAN leg is a secondary bearer and may be created next to an existing LTE bearer, LTE (radio resource control) RRC signalling may be used between the UE and the RAN to request credentials from the WLAN. RRC protocol is used between RAN and UE. In a collocated case RRC signaling may be used to provide credentials as the WLAN/3GPP radio controller may be a single entity. In a generic case the WLAN and LTE may communicate via a suitable protocol but the RRC could deliver the value to UE.

As an option, UE may receive, from a first network, access information associated with a second network, e.g., WLAN authentication credentials from 3GPP RAN, even if not being in active mode (and having ongoing data transmission). For example as part of 3GPP/WLAN Interworking messaging (standardized into 3GPP release 12) UE may receive WLAN credentials to be used according to the method (e.g. to optimize authentication and reduce core network signalling).

A method such as that described above and shown in the flowchart of FIG. 3 may be performed during bearer establishment, for example LTE bearer establishment.

In this example, during LTE bearer establishment, a UE may establish a LTE default bearer. This bearer setup may include indication from the eNB to setup WLAN aggregation bearer and/or a UE could request permission to do the same from eNB. UE may provide a WLAN identifier, such as a WLAN MAC address, to the eNB as part of procedure. Alternatively there may be separate dedicated signalling to setup WLAN aggregation. An eNB may communicate with the WLAN and request access information in the form of temporary credentials (e.g. username+secret) for the WLAN offload. As an alternative, eNB may create or allocate the access information, e.g. credentials, and provide the access information to the WLAN (this may require using e.g. 3GPP range or alike to avoid collision with credentials created by WLAN e.g. for devices without SIM).

Alternatively credentials may be created in external network element which is accessible to RAN and WLAN and which may be identified by created credentials (for example. via realm in the username).For example a LDAP and an AAA server could work together to create credentials, or HSS.

The credentials may be provided to the UE. UE may run appropriate EAP authentication with the WLAN using the credentials provided to the UE. EAP authentication may be, for example, EAP-TTLS/MSCHAPV2 suite. WLAN recognizes the realm and authenticates the UE locally in the WLAN. UE may request IP address using DHCP for the WLAN connection. WLAN may associate the request to the LTE bearer and provide either same IP address as is used on LTE bearer or internally may the LTE bearer to the WLAN leg in the case that some tunneling mechanism is used over WLAN leg. The eNB may be able to use both WLAN and LTE legs with the same S1 endpoint.

Alternatively, an eNB may decide to move the UE to WLAN during ongoing communication, thus the method may be performed outside of bearer establishment.

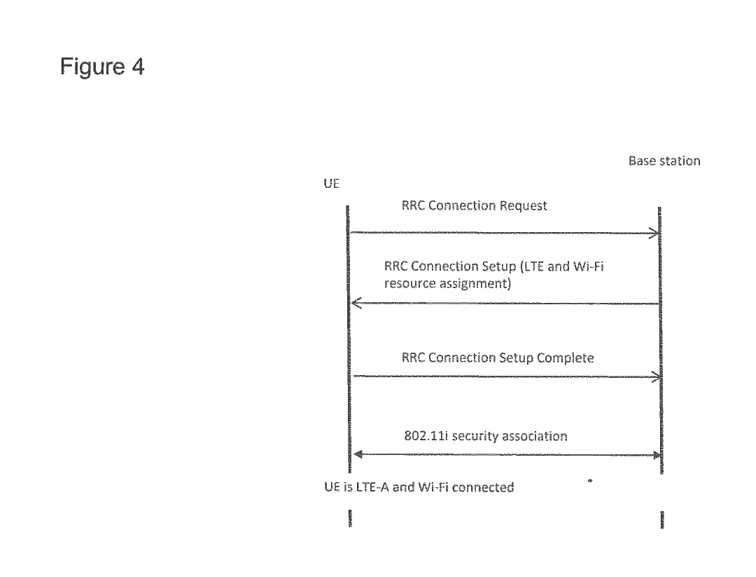

FIG. 4 shows the message flow within a first network for connection of a UE with a first network, LTE-A and a second network, WLAN. In the case where a UE has ongoing communication in LTE or establishes radio resources for LTE communication, the UE may be LTE authenticated.

An example of an authentication procedure which may be used in combination with the methods described above comprises the following steps. A UE connects to eNB. Optionally, an eNB may indicate to UE the WLAN networks to monitor; equally UE may indicate signal quality reports from monitored WLAN networks. When the eNB decides to setup WLAN aggregation with the local WLAN node, the eNB prepares MSChapV2 credentials (username, password) for the user and installs them to a local AAA server.

Username is of form user@realm. AAA server is identifiable by the realm part of the username for the WLAN. The eNB commands aggregation to UE providing UE the assigned credentials and WLAN network identity (MAC address, SSID as an example (BSS service ID)). The UE associates with the WLAN network and authenticates using EAP-TTLS/MSChapV2. WLAN network propagates EAP authentication messages to the AAA server identified by the realm part of the username. Since this AAA server uses eNB managed user credentials for user authentication, the eNB is able to control authentication process and authorize access. AAA completes EAP authentication with the UE and provides PMKs to the WLAN network. UE derives locally the same PMKs. The UE communication with the eNB is now carried over potentially via both eNB and WLAN legs.

Since eNB manages the users in the AAA server it may at any time remove the user from the WLAN and force UE back to eNB.

As an option, RAN may provide directly or via MME challenge and expected response to WLAN network to be used as part of EAM-SIM/AKA/AKA′ authentication. For example HSS is requested to provide multiple challenge and response pairs when UE is authenticated in 3G/LTE network. Thus 3G/LTE network has unused challenge(s) and response(s). 3G/LTE may provide one set to WLAN network enabling the WLAN network to execute (U)SIM based authentication for selected UE without involving HSS, together with UE/user identity enabling the WLAN network to use correct authentication information for a specific user/UE.

In an embodiment, if a RAN decides to utilize WLAN (LTE+WLAN or move UE to WLAN), the RAN may request the WLAN to provide a secret for the UE enabling secure connection establishment in WLAN. RAN may share user/UE identity to WLAN. Example identities that UE identifies itself when accessing Wi-Fi network may be a RAN allocated temporary identity (such as PTID) or a MAC address.

The RAN may communicate WLAN access related info to the UE, for example, RAN allocated temporary user/UE identity, such as PTID, WLAN (provided) secret, IP address to be used in WLAN access, QoS related information, such as diffserve code points (DSCP) marking, to be used in Wi-Fi access when continuing existing connection(s) over WLAN. A UE may connect to the WLAN.

The UE may trigger, for example, an access network query protocol (ANQP) query, WLAN management procedure or access point (AP) probe. The message from the UE to the AP may be extended to include temporary RAN allocated user/UE identity.

After a WLAN AP response to the UE (if response is expected), the WLAN AP may start establishing secure connection with the UE by sending Non-Value to the UE. At this point the WLAN AP has associated user/UE temporary identity with the used secret.

UE and WLAN AP may exchange messages to setup secure connection according to 802.11i, using the secret. Only a UE with a valid temporary identity and secret is able to setup secured radio connection correctly. As secret and temporary identity were transferred e.g. in RRC message, the chances of another UE being able to do so are non-existing/extremely small.

An example of an authentication procedure for a eNB aggregation with WLAN may comprise the following steps. A UE connects to eNB and provides own MAC address. Optionally, the eNB may indicate to UE the WLAN networks to monitor; equally UE may indicate signal quality reports from monitored WLAN networks. When the eNB decides to setup WLAN aggregation with the local WLAN node, the eNB prepares PMKs (UL/DL) for the WLAN together with the UE MAC; WLAN is prepared to accept UE access using this UL PMK. In DL the DL PMK is used. eNB commands aggregation to UE providing UE the PMK and WLAN network identity (MAC address, SSID as an example). UE associates with the WLAN network and setups secure connection using the provided PMK. WLAN is able to identify the UE based on MAC address and apply correct PMK to the session. EAP authentication may be skipped. The UE communication with the eNB is now carried over potentially via both eNB and WLAN legs. Since eNB manages the PMKs it may at any time remove the PMK from the WLAN and force UE back to eNB.

In this case, a UE may now access WLAN without executing normal authentication or any EAP messages. Connection establishment uses solely RAN and WLAN messaging and requires only few messages in addition to 802.11i messages. Wi-Fi network functions may use user/UE temporary identity to enable RAN to associate LTE and Wi-Fi legs to the same user/UE.

In the case where RAN provides an (Internet protocol) IP address to the UE, the UE may skip DHCP procedure and start using the assigned IP address.

In the case where RAN provides Quality of Service (QoS), DSCP marking (or similar QOS) details to the UE, the UE shall start marking uplink packets accordingly e.g. to enable traffic prioritization/QoS mechanisms in WLAN.

No access is made to home operator AAA/HSS network; all WLAN related AAA actions may stay within WLAN/RAN. There is no need to do any AAA related signalling toward home network as is done with regular 3GPP WLAN. This may allow faster WLAN connection setup and simplify the environment especially in integrated LTE/WLAN nodes. A decision to use WLAN is made locally in RAN node.

Alternatively, or in addition, authentication may take place within the RAN using a WLAN/RAN interface. In this example, the local AAA interface would not be used. Communication with the RAN would happen via this WLAN/RAN interface, including authentication and authorization. Actions could be internal to WLAN too if RAN is able to setup the data via this interface.

LTE bearer setup is secure and the same security may be re-used on WLAN bearer setup.

All data may be sent via EPS. The EPS may take care of charging so that there is no separate WLAN charging.

WLAN bearer may be an integral part of LTE network (or other 3GPP networks). It is local to RAN without additional external interfaces (like AAA) from RAN site.

3GPP has specified WLCP protocol in 3GPP Release 12 for multiple bearers over WLAN radio. LTE/WLAN aggregation may utilize the WLCP protocol if multiple LTE bearers are to be aggregated over WLAN.

It should be understood that each block of the flowchart of FIG. 3 or 4 and any combination thereof may be implemented by various means or their combinations, such as hardware, software, firmware, one or more processors and/or circuitry.

Embodiments described above by means of FIGS. 1 to 4 may be implemented on an apparatus, such as a node, host or server, or in a unit, module, etc. providing control functions as shown in FIG. 5 or on a mobile device (or in a unit, module etc. in the mobile device) such as that of FIG. 2. FIG. 5 shows an example of such an apparatus. In some embodiments, a base station comprises a separate unit or module for carrying out control functions. In other embodiments, the control functions may be provided by another network element such as a radio network controller or a spectrum controller. The apparatus 300 may be arranged to provide control on communications in the service area of the system. The apparatus 300 comprises at least one memory 301, at least one data processing unit 302, 303 and an input/output interface 304. Via the interface the control apparatus may be coupled to a receiver and a transmitter of the base station. The receiver and/or the transmitter may be implemented as a radio front end or a remote radio head.

For example, an example of the apparatus 300 may be configured to execute an appropriate software code to provide the control functions. Control functions may include at least one of controlling receiving, at a user equipment, access information from a first network, said access information associated with a second network.

An example of the apparatus 300 may be configured to execute an appropriate software code to provide the control functions. Control functions may include the first and second network using different radio access technologies and using said access information in communication with the second network; providing, by a first network, access information associated with a second network to a user equipment, said access information for communication with the second network, said first and second network using different radio access technologies.

An example of the apparatus 300 may be configured to execute an appropriate software code to provide the control functions. Control functions may include detecting at a second network, a user equipment communicating with the second network, said user equipment authenticated with a first network, the first and second network using different radio access technologies and allowing the user equipment to access the second network based on access information used in the user equipment authentication with the first network.

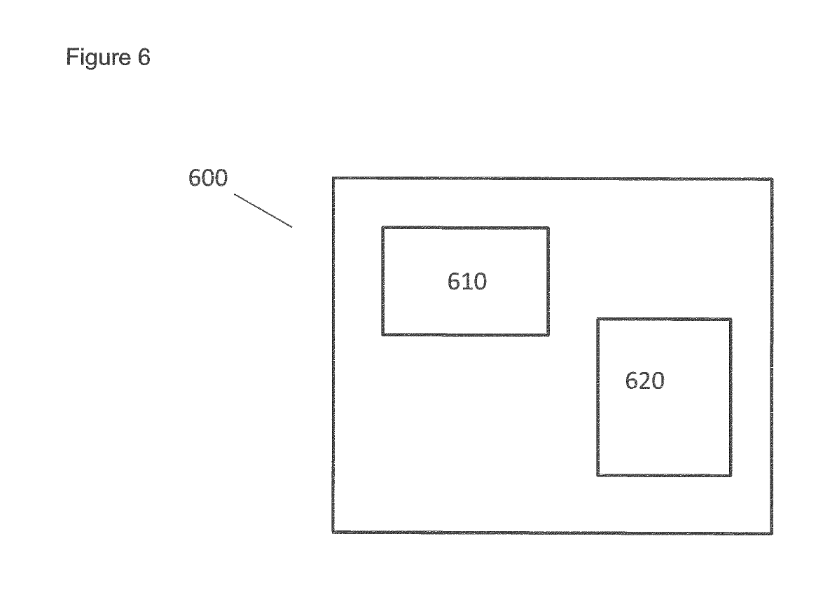

An example of an apparatus 600 shown in FIG. 6 comprises means 610 for controlling receiving, at a user equipment, access information from a first network, said access information associated with a second network, the first and second network using different radio access technologies and means 620 for using said access information in communication with the second network.

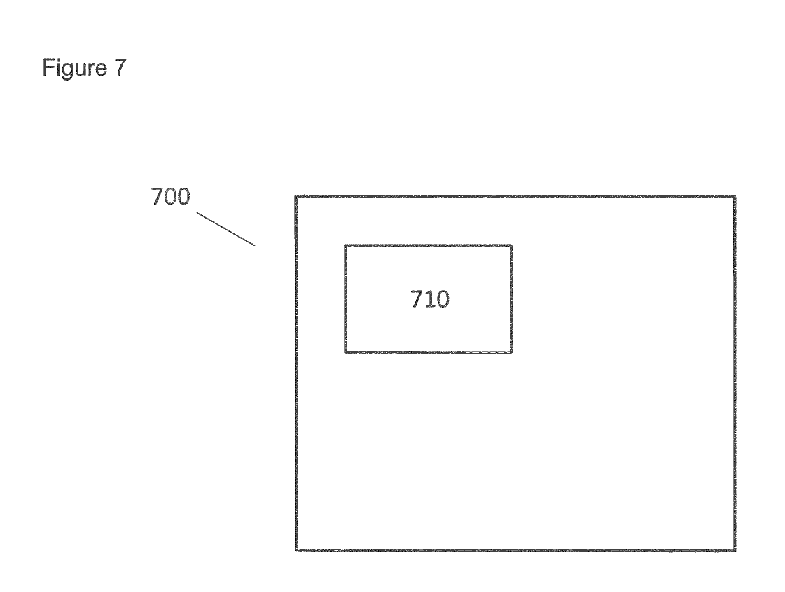

An example of an apparatus 700 shown in FIG. 7 comprises means 710 for providing, by a first network, access information associated with a second network to a user equipment, said access information for communication with the second network, said first and second network using different radio access technologies.

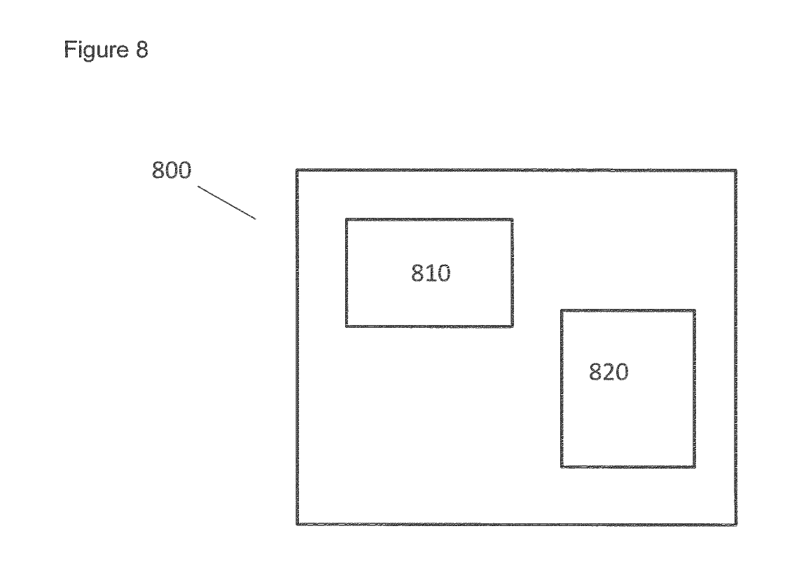

An example of an apparatus 800 shown in FIG. 8 comprises means 810 for detecting at a second network, a user equipment communicating with the second network, said user equipment authenticated with a first network, the first and second network using different radio access technologies and means 820 for allowing the user equipment to access the second network based on access information used in the user equipment authentication with the first network.

It should be understood that the apparatuses may include or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE, similar principles may be applied to any other communication system or radio access technology, such as 5G. Embodiments are generally applicable for access systems using licensed or unlicensed spectrum. RAN assigned information may be used to optimise UE WLAN access regardless of how data packets are treated (although LTE/WLAN integration/aggregation is used as an example). WLAN authentication in accordance with embodiments may be performed without using carrier aggregation/dual connectivity between a first network and a second network. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments as described above by means of FIGS. 1 to 5 may be implemented by computer software executable by a data processor, at least one data processing unit or process of a device, such as a base station, e.g. eNB, or a UE, in, e.g., the processor entity, or by hardware, or by a combination of software and hardware. Computer software or program, also called program product, including software routines, applets and/or macros, may be stored in any apparatus-readable data storage medium or distribution medium and they include program instructions to perform particular tasks. An apparatus-readable data storage medium or distribution medium may be a non-transitory medium. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), FPGA, gate level circuits and processors based on multi-core processor architecture, as non-limiting examples.

Embodiments described above in relation to FIGS. 1 to 5 may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1-53. (canceled)

54. A method comprising:
deciding, by a cellular network node, to set up a wireless local area network aggregation for a user equipment;
receiving a media access control address from the user equipment or generating a user equipment identity, and
providing to, or negotiating with, a wireless local area network, a security key for the wireless local area network aggregation wherein the security key for usage in access of the user equipment to the wireless local area network, and wherein the user equipment is identified based on the media access control address or based on the generated user equipment identity.

55. The method according to claim 54, wherein the wireless local area network aggregation is a secondary radio bearer of the user equipment.

56. The method according to claim 54, wherein the security key is a pair-wise master key to be used in a pair-wise master key security association.

57. The method according to claim 54, wherein the user equipment identity is temporary user equipment identity information or pseudo terminal identity information.

58. The method according to claim 54, further comprising: transmitting the media access control address or the user equipment identity to the wireless local area network.

59. The method according to claim 54, further comprising: transmitting to the wireless local area network wireless local area network authentication credentials and/or wireless local area network identification information for usage in an authentication procedure of the user equipment with the wireless local area network

60. A method comprising:
receiving, by a wireless local area network node, a media access control address of user equipment or a user equipment identity information from a cellular network node, or
receiving a request from the cellular network node for user equipment identity information, and
receiving from, or negotiating with, the cellular network node, a security key for a wireless local area network aggregation wherein the security key for usage in access of the user equipment to the wireless local area network, and wherein the user equipment is identified based on the media access control address or the user equipment identity information.

61. The method according to claim 60, wherein the security key is used as a pair-wise master key in a pair-wise master key security association.

62. The method according to claim 60, wherein the security key is used as a pair-wise master key in a pair-wise master key security association further comprising: storing the pair-wise master key in a pair-wise master key security association.

63. The method according to claim 60, further comprising: executing a 4-way handshake with the user equipment.

64. The method according to claim 60, further comprising: receiving from the cellular network node wireless local area network authentication credentials and/or wireless local area network identification information for usage in an authentication procedure of the user equipment with the wireless local area network.

65. The method according to claim 60, further comprising: carrying out extensible authentication protocol authentication with the user equipment.

66. An apparatus comprising or being comprised in a cellular network node, the apparatus comprising:
at least one processor and at least one memory including computer program code, the at least one memory and the computer program code configured to, with the at least one processor, cause the apparatus at least to:
decide, to set up a wireless local area network aggregation for user equipment;
receive a media access control address from the user equipment or generating a user equipment identity, and
provide to, or negotiate with, a wireless local area network, a security key for the wireless local area network aggregation wherein the security key for usage in access of the user equipment to the wireless local area network, and wherein the user equipment is identified based on the media access control address or based on the generated user equipment identity.

67. An apparatus according to claim 66, wherein the wireless local area network aggregation is a secondary radio bearer of the user equipment.

68. The apparatus according to claim 66, wherein the security key is a pair-wise master key to be used in a pair-wise master key security association.

69. The apparatus according to claim 66, wherein the user equipment identity is temporary user equipment identity information or pseudo terminal identity information.

70. The apparatus according to claim 66, further comprising causing the apparatus to: transmit the media access control address or the user equipment identity to the wireless local area network.

71. The apparatus according to claim 66, further comprising causing the apparatus to:
transmit to the wireless local area network wireless local area network authentication credentials and/or wireless local area network identification information for being used in an authentication procedure of the user equipment with the wireless local area network.

72. An apparatus comprising or being comprised in a wireless local area network node, the apparatus comprising:
at least one processor and at least one memory including a computer program code, the at least one memory and the computer program code configured to, with the at least one processor, cause the apparatus at least to:
receive, a media access control address of user equipment or a user equipment identity information from a cellular network node, or
receive a request from the cellular network node for user equipment identity information, and
receive from, or negotiate with, the cellular network node, a security key for a wireless local area network aggregation wherein the security key for usage in access of the user equipment to the wireless local area network, and wherein the user equipment is identified based on the media access control address or the user equipment identity information.

73. The apparatus according to claim 72, wherein the security key is used as a pair-wise master key in a pair-wise master key security association.

74. The apparatus according to claim 72, wherein the security key is used as a pair-wise master key in a pair-wise master key security association further comprising: storing the pair-wise master key in a pair-wise master key security association.

75. The apparatus according to claim 72, further comprising causing the apparatus to: execute a 4-way handshake with the user equipment.

76. The apparatus according to claim 72, further comprising causing the apparatus to: receive from the cellular network node wireless local area network authentication credentials and/or wireless local area network identification information for being used in an authentication procedure of the user equipment with the wireless local area network.

77. The apparatus according to claim 72, further comprising causing the apparatus to: carry out extensible authentication protocol authentication with the user equipment.
